(19) United States
(12) Patent Application Publication
(10) Pub. No.: US 2015/0091855 A1
(43) Pub. Date: Apr. 2, 2015

(54) OLED TOUCH DEVICE

(71) Applicant: Rich IP Technology Inc., Taipei (TW)

(72) Inventors: Han-Chang CHEN, Taipei (TW); Yen-Hung TU, Taipei (TW); Chung-Lin CHIA, Taipei (TW); Jen-Chieh CHANG, Taipei (TW); Chih-Wen WU, Taipei (TW)

(21) Appl. No.: 14/471,735

(22) Filed: Aug. 28, 2014

(30) Foreign Application Priority Data
Sep. 30, 2013 (TW) 102135419

(51) Int. Cl. G06F 3/044

(52) U.S. Cl. CPC G06F 3/044
USPC 345/174

(57) ABSTRACT

An OLED touch device including at least one OLED and a controller, each of the at least one OLED having: a first substrate; a first electrode located on the first substrate; an organic material structure layer located on the first electrode; a second electrode located on the organic material structure layer; and a second substrate located on the second electrode; wherein, the control unit is used to apply a combined voltage source across the first electrode and the second electrode of at least one of the at least one OLED to provide a light emitting function and/or a touch detection function, wherein the combined voltage source has a DC voltage component and an AC voltage component.

### BACKGROUND OF THE INVENTION

1. Field of the Invention

The present invention relates to a touch device, especially to an OLED (organic light emitting diode) touch device.

2. Description of the Related Art

General touch apparatuses have a touch module stacked on a screen. However, this kind of touch apparatuses tends to have larger depths, which can fail to meet the market requirements on lightness and thinness, and can result in higher material cost.

To cope with this issue, one solution is to integrate two layers of same material, of which one layer belongs to a screen and the other layer belongs to a touch module, into a single layer. However, the depth of a touch apparatus reduced by this kind of designs still cannot meet the requirements of some high end products.

Another solution is to integrate a touch function into a display, generally by adding extra electrodes on a display circuit layer to form touch capacitors. However, this kind of designs tends to reduce product yield rate and increase manufacturing cost.

To solve the foregoing problems, a novel, slim, and easy-to-manufacture touch apparatus is needed.

### SUMMARY OF THE INVENTION

One objective of the present invention is to disclose an OLED touch device, which is capable of providing a light emitting function and/or a touch detection function by applying a combined voltage source across an OLED structure.

Another objective of the present invention is to disclose an OLED touch device, which is capable of using two substrates to provide two touch planes.

Another objective of the present invention is to disclose an OLED touch device, which is capable of detecting a touch event by sensing an amplitude variation, a phase variation, or a frequency variation of an AC (alternating current) voltage of a combined voltage source.

Another objective of the present invention is to disclose an OLED touch device, which is capable of providing four operation modes by enabling/disabling a DC (direct current) voltage component and/or an AC voltage component of a combined voltage source.

Still another objective of the present invention is to disclose an OLED touch device, which is capable of simplifying the structure of a touch apparatus to reduce the depth, promote the yield rate, and cut down the cost thereof.

To attain the foregoing objectives, an OLED touch device having at least one OLED and a controller is proposed, each of the at least one OLED including:

a first substrate;

a first electrode located on the first substrate;

an organic material structure layer located on the first electrode;

a second electrode located on the organic material structure layer; and

a second substrate located on the second electrode;

wherein, the control unit is used to apply a combined voltage source across the first electrode and the second electrode of at least one of the at least one OLED to provide a light emitting function and/or a touch detection function, wherein the combined voltage source has a DC voltage component and an AC voltage component, the DC voltage component being used to produce a DC current flowing through the organic material structure layer to provide the light emitting function, and the AC voltage component being used as a touch detection signal, of which a parameter variation is detected by the controller to indicate a touch event, to provide the touch detection function.

In one embodiment, the organic material structure layer is selected from a group consisting of an N type organic material layer and a P type organic material layer.

In one embodiment, the first substrate is selected from a group consisting of glass, PET (polyethylene terephthalate), and glass epoxy resin.

In one embodiment, the second substrate is selected from a group consisting of glass, and PET.

In one embodiment, the first electrode is selected from a group consisting of a transparent electrode and an opaque electrode.

In one embodiment, the second electrode is a transparent electrode.

In one embodiment, the OLED has a light emission structure selected from a group consisting of a top-emission structure, a bottom-emission structure, and any combination thereof.

In one embodiment, the second substrate is used to provide a touch plane.

In one embodiment, the first substrate is used to provide another touch plane.

In one embodiment, the parameter variation is selected from a group consisting of amplitude variation, phase variation, and frequency variation.

In one embodiment, the touch detection function is selected from a group consisting of a self-capacitance touch detection function, a mutual-capacitance touch detection function, and a surface-capacitance touch detection function.

In one embodiment, the control unit has a first operation mode for providing the light emitting function and the touch detection function at same time.

In one embodiment, the control unit has a second operation mode for providing only the touch detection function.

In one embodiment, the control unit has a third operation mode for providing only the light emitting function.

In one embodiment, the control unit has a fourth operation mode, in which both the touch detection function and the light emitting function are shut down.

In one embodiment, the at least one OLED forms an OLED array, and the control unit has a scan unit for driving the OLED array.

In one embodiment, the OLED array is selected from a group consisting of a passive OLED array and an active OLED array.

In one embodiment, the at least one OLED is used to form an OLED light source.

In one embodiment, the first electrode of the OLED light source is wired to an external electrode for providing a touch operation.

In one embodiment, the second electrode of the OLED light source is wired to an external electrode for providing a touch operation.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1a illustrates an OLED testing circuit.

FIG. 1b illustrates a current-voltage characteristic curve and a luminance-current characteristic curve.

FIG. 1c illustrates an equivalent circuit of the OLED testing circuit of FIG. 1a when an OLED thereof is situated in an off state, wherein the OLED is equivalent to a capacitor C_{OLED}.

FIG. 1d illustrates an equivalent circuit of the OLED testing circuit of FIG. 1a when the OLED is situated in an on state, wherein the OLED is equivalent to a resistor R_{OLED}.

FIG. 2a shows an illustrative waveform of a combined voltage source V_{S} of FIG. 1a.

FIG. 2b illustrates a scenario where the combined voltage source of FIG. 1a is used to drive an OLED for performing a touch detection function.

FIG. 3 illustrates an embodiment of the OLED touch device of the present invention.

FIG. 4a illustrates the block diagram of another embodiment of the OLED touch device of the present invention.

FIG. 4b illustrates the block diagram of another embodiment of the OLED touch device of the present invention.

FIG. 5 illustrates plural applications of the OLED touch device of the present invention.

FIG. 6-7 illustrates an OLED light source of the present invention using an extended wire to provide an on/off switching function and/or a dimming function.

### DETAILED DESCRIPTION OF THE PREFERRED EMBODIMENTS

The present invention will be described in more detail hereinafter with reference to the accompanying drawings that show the preferred embodiments of the invention.

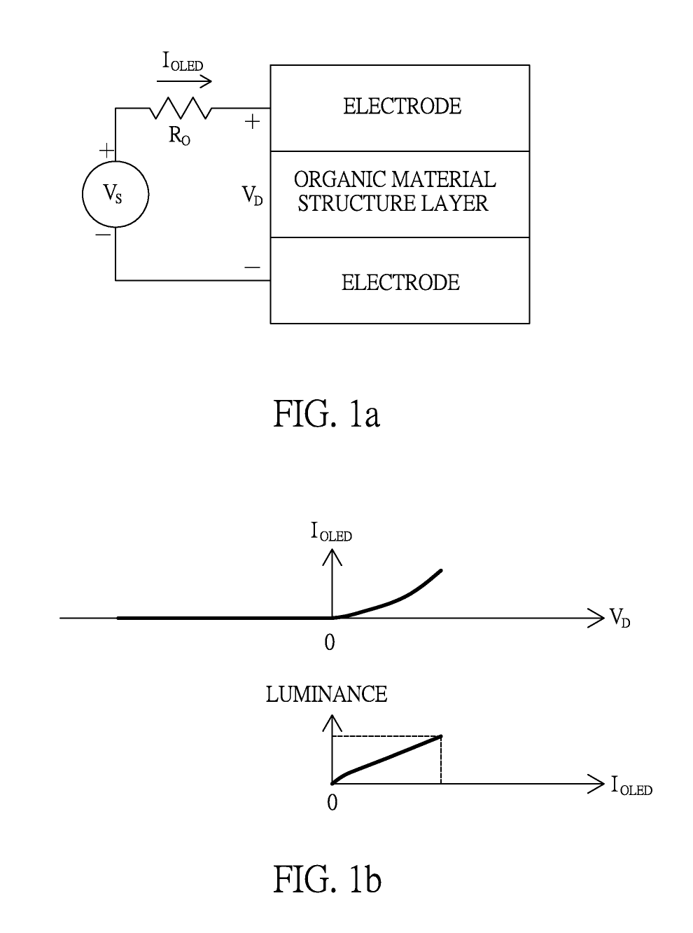

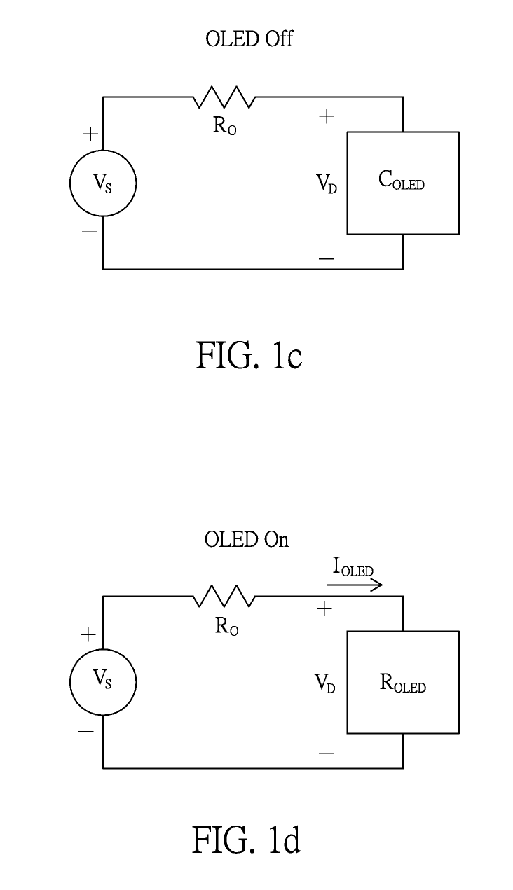

First, the principle of the present invention will be illustrated below. Please refer to FIG. 1a, which illustrates an OLED testing circuit; and FIG. 1b, which illustrates a current-voltage characteristic curve and a luminance-current characteristic curve.

As illustrated in FIG. 1a and FIG. 1b, when a voltage drop V_{D} across the OLED is below a threshold, the OLED is situated in an off state; and when the voltage drop V_{D} across the OLED is above the threshold, the OLED is situated in an on state and a current I_{OLED} will flow through the OLED to make the OLED emit light. FIG. 1 c illustrates an equivalent circuit of the OLED testing circuit when the OLED is situated in the off state, wherein the OLED is equivalent to a capacitor C_{OLED}; and FIG. 1d illustrates an equivalent circuit of the OLED testing circuit when the OLED is situated in the on state, wherein the OLED is equivalent to a resistor R_{OLED}.

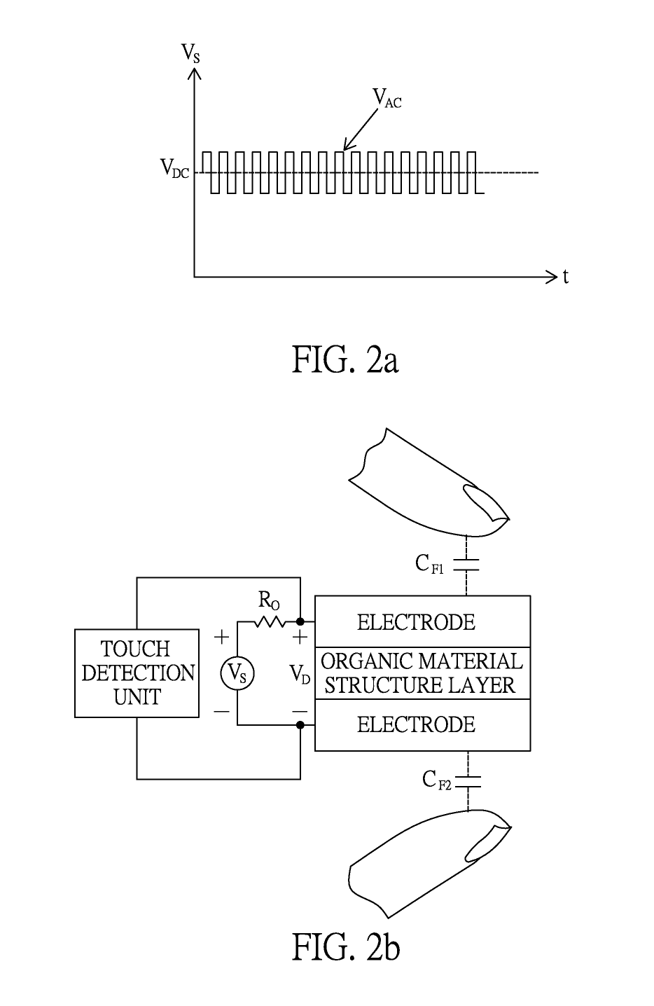

When the voltage source V_{S} of FIG. 1a is a combined voltage source having a DC voltage and an AC voltage (FIG. 2a shows an illustrative waveform. Although the AC voltage V_{AC} shown in FIG. 2a is a square wave signal, it also can be a sine wave signal or other AC waveform signals.), the average luminance of the OLED will be determined by the DC voltage and be independent of the AC voltage, and the AC voltage can therefore be used to detect a touch event. That is, by using the combined voltage source to drive the OLED, the touch detection can be independent of the average luminance of the OLED.

Please refer to FIG. 2b, which illustrates a scenario where the combined voltage source is used to drive the OLED for performing a touch detection function. As illustrated in FIG. 2b, when a finger is approaching the OLED, an effective capacitance C_{F1} or C_{F2} will be induced to cause a parameter variation of the AC component of the voltage V_{D} across the OLED, and the parameter variation can be used for a touch detection function, wherein, the parameter variation can be amplitude variation, phase variation, or frequency variation, and the touch detection function can be a self-capacitance touch detection function, a mutual-capacitance touch detection function, or a surface-capacitance touch detection function. As the self-capacitance touch detection function, mutual-capacitance touch detection function, and surface-capacitance touch detection function are well known and can be found in prior art, their principles will not be addressed here.

Besides, by enabling/disabling the DC component and AC component, the OLED can possess multiple operation modes, wherein, when the OLED operates in a first operation mode, both the DC component and the AC component of the combined voltage source will be enabled to provide a light emitting function and the touch detection function; when the OLED operates in a second operation mode, the DC component will be disabled and the AC component will be enabled to provide only the touch detection function; when the OLED operates in a third operation mode, the DC component will be enabled and the AC component will be disabled to provide only the light emitting function; and when the OLED operates in a fourth operation mode, both the DC component and the AC component will be disabled, and the touch detection function and the light emitting function will both be shut down.

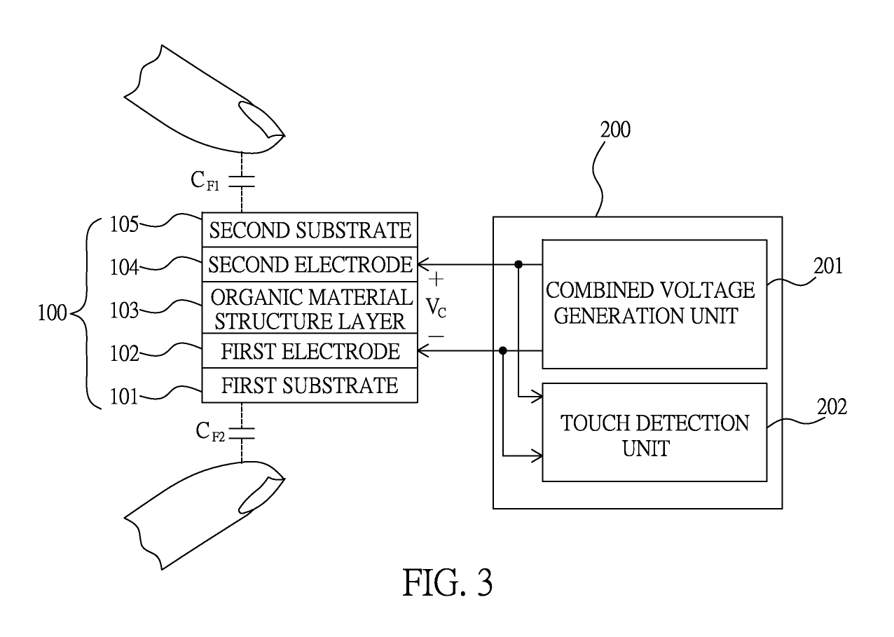

Based on the principles mentioned above, the present invention proposes an OLED touch device. Please refer to FIG. 3, which illustrates an embodiment of the OLED touch device of the present invention. As illustrated in FIG. 3, the OLED touch device includes at least one OLED 100 and a control unit 200, wherein each OLED 100 has a first substrate 101, a first electrode 102, an organic material structure layer 103, a second electrode 104, and a second substrate 105; and the control unit 200 has a combined voltage generation unit 201 and a touch detection unit 202.

The structure of the OLED 100 can be a top-emission structure, a bottom-emission structure, or any combination of the top-emission structure and the bottom-emission structure.

The first substrate 101 can be made of glass, PET, or glass epoxy resin.

The first electrode 102, located on the first substrate 101, can be a transparent electrode or an opaque electrode.

The organic material structure layer 103, located on the first electrode 102, can be made of an N type organic material layer or a P type organic material layer.

The second electrode 104, located on the organic material structure layer 103, is a transparent electrode.

The second substrate 105, located on the second electrode 104, can be made of glass or PET.

In the OLED touch device, the combined voltage generation unit 201 of the control unit 200 is used to apply a combined voltage source V_{C} across the first electrode 102 and the second electrode 104 of the OLED 100 to provide a light emitting function and/or a touch detection function, wherein the combined voltage source V_{C} has a DC voltage component and an AC voltage component, the DC voltage component being used to produce a DC current flowing through the organic material structure layer 103 to provide the light emitting function, and the AC voltage component being used as a touch detection signal, of which a parameter variation is detected by the touch detection unit 202 of the controller 200 to indicate a touch event, to provide the touch detection function. The touch detection function can be a self-capacitance touch detection function, a mutual-capacitance touch detection function, or a surface-capacitance touch detection function, and the parameter variation can be amplitude variation, phase variation, or frequency variation. Besides, the combined voltage generation unit 201 can use an active circuit (including transistors or an amplifier) or a passive circuit to combine a DC voltage source and an AC voltage source to generate the combined voltage source V_{C}, wherein both the DC voltage source and the AC voltage source can be enabled or disabled.

The second substrate 105 is used to provide a touch plane, and the first substrate 101 is used to provide another touch plane.

The control unit 200 has multiple operation modes, wherein, when the control unit 200 operates in a first operation mode, the combined voltage generation unit 201 will provide the combined voltage source V_{C} with a DC component and an AC component, and the touch detection unit 202 will detect the AC component of the combined voltage source V_{C}, so as to provide the light emitting function and the touch detection function at same time; when the control unit 200 operates in a second operation mode, the combined voltage generation unit 201 will provide the combined voltage source V_{C} with an AC component only, and the control unit 200 will provide only the touch detection function; when the control unit 200 operates in a third operation mode, the combined voltage generation unit 201 will provide the combined voltage source V_{C} with an DC component only, and the control unit 200 will provide only the light emitting function; and when the control unit 200 operates in a fourth operation mode, the combined voltage generation unit 201 will shut down the combined voltage source V_{C}, and both the touch detection function and the light emitting function will be disabled. Besides, the control unit 200 can further possess a communication interface to communicate with an information processing unit.

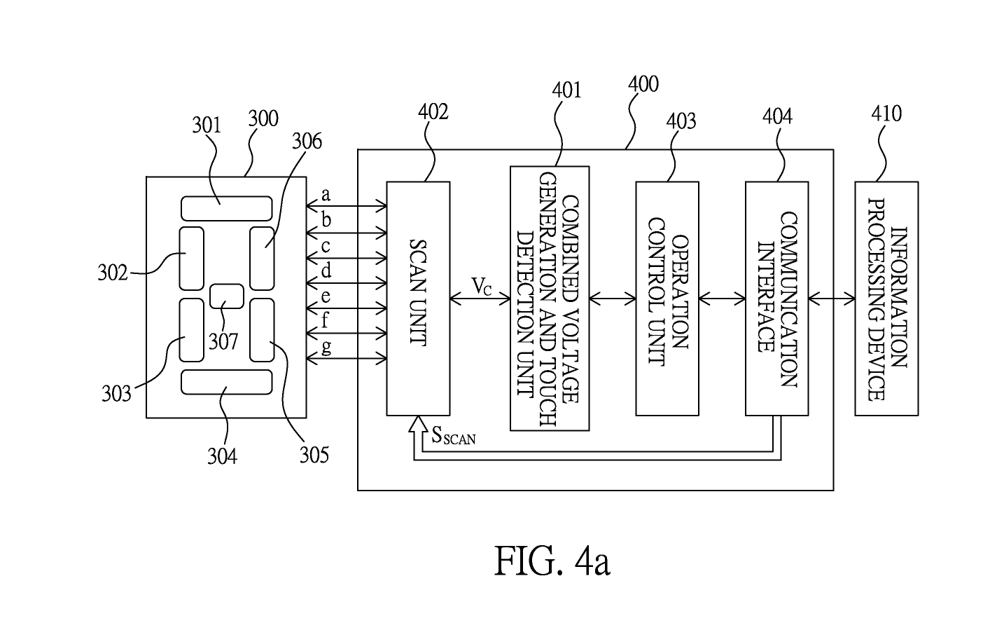

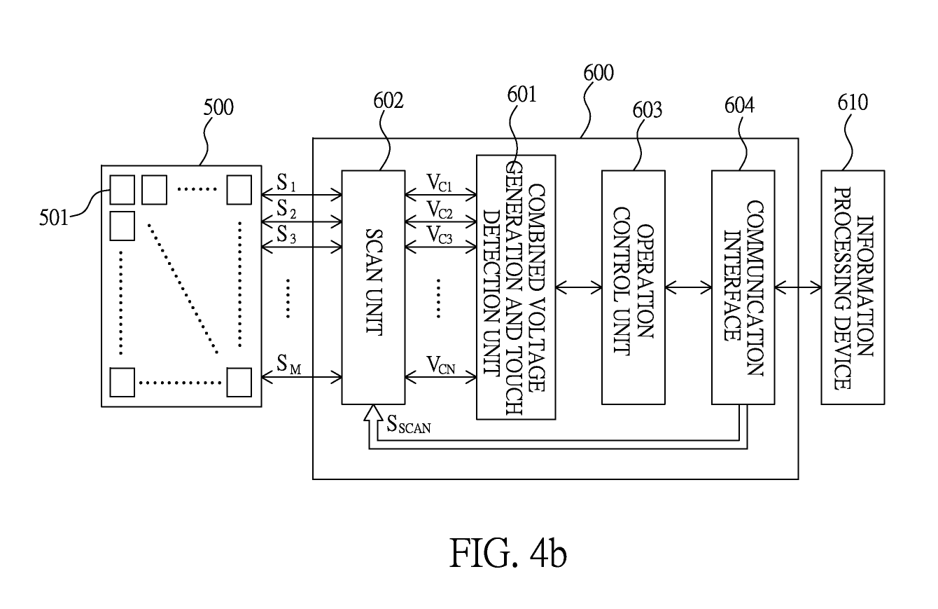

When the at least one OLED 100 is used to form an OLED array, the control unit 200 can further possess a scan unit to drive the OLED array. Please refer to FIG. 4a, which illustrates the block diagram of another embodiment of the OLED touch device of the present invention. As illustrated in FIG. 4a, the OLED touch device has a passive OLED array 300 and a control unit 400.

The passive OLED array 300 has OLEDs 301-307 to form a seven-segment display unit, wherein, each of the OLEDs 301-307 has same structure as the OLED 100 of FIG. 3.

The control unit 400 has a combined voltage generation and touch detection unit 401, a scan unit 402, an operation control unit 403, and a communication interface 404.

The combined voltage generation and touch detection unit 401 is used to generate a combined voltage source V_{C} and provide a touch detection function, wherein the combined voltage source V_{C} has a DC voltage component and an AC voltage component, the DC voltage component being used to produce a DC current flowing through an OLED of the OLEDs 301-307 to make the OLED emit light, and the AC voltage component being used as a touch detection signal. The combined voltage generation and touch detection unit 401 provides the touch detection function by detecting a parameter variation of the touch detection signal to indicate a touch event, wherein the touch detection function can be a self-capacitance touch detection function, a mutual-capacitance touch detection function, or a surface-capacitance touch detection function, and the parameter variation can be amplitude variation, phase variation, or frequency variation.

The scan unit 402 drives the OLEDs 301-307 sequentially with the combined voltage source V_{C} under the control of a scan control signal S_{SCAN}.

The operation control unit 403, apart from generating the scan control signal S_{SCAN} to control the operation of the scan unit 402, can also interact with the combined voltage generation and touch detection unit 401 and exchange data with an information processing device 410 via the communication interface 404, wherein the data can be seven-segment display data and/or touch detection data, and the information processing device 410 can execute a corresponding procedure according to the touch detection data.

Please refer to FIG. 4b, which illustrates the block diagram of another embodiment of the OLED touch device of the present invention. As illustrated in FIG. 4b, the OLED touch device has an active OLED array 500 and a control unit 600.

The active OLED array 500 includes plural OLEDs 501, and is driven by an active circuit, wherein each of the plural OLEDs 501 has same structure as the OLED 100 of FIG. 3.

The control unit 600 has a combined voltage generation and touch detection unit 601, a scan unit 602, an operation control unit 603, and a communication interface 604.

The combined voltage generation and touch detection unit 601 is used to generate N combined voltage sources V_{C1}-V_{CN} and provide a touch detection function, wherein each of the combined voltage sources V_{C1}-V_{CN} has a DC voltage component and an AC voltage component, the DC voltage component being used to produce a DC current flowing through an OLED of the plural OLEDs 501 to make the OLED emit light, and the AC voltage component being used as a touch detection signal. The combined voltage generation and touch detection unit 601 provides the touch detection function by detecting a parameter variation of the touch detection signal to indicate a touch event, wherein the touch detection function can be a self-capacitance touch detection function, a mutual-capacitance touch detection function, or a surface-capacitance touch detection function, and the parameter variation can be amplitude variation, phase variation, or frequency variation.

The scan unit 602 transmits the combined voltage sources V_{C1}-V_{CN} to N signals of M driving signals S₁-S_{M} under the control of a scan control signal S_{SCAN}, to drive the plural OLEDs 501, wherein the selection of the N signals varies with the content of the scan control signal S_{SCAN}.

The operation control unit 603, apart from generating the scan control signal S_{SCAN} to control the operation of the scan unit 602, can also interact with the combined voltage generation and touch detection unit 601 and exchange data with an information processing device 610 via the communication interface 604, wherein the data can be display data for the active OLED array 500 and/or touch detection data, and the information processing device 610 can execute a corresponding procedure according to the touch detection data.

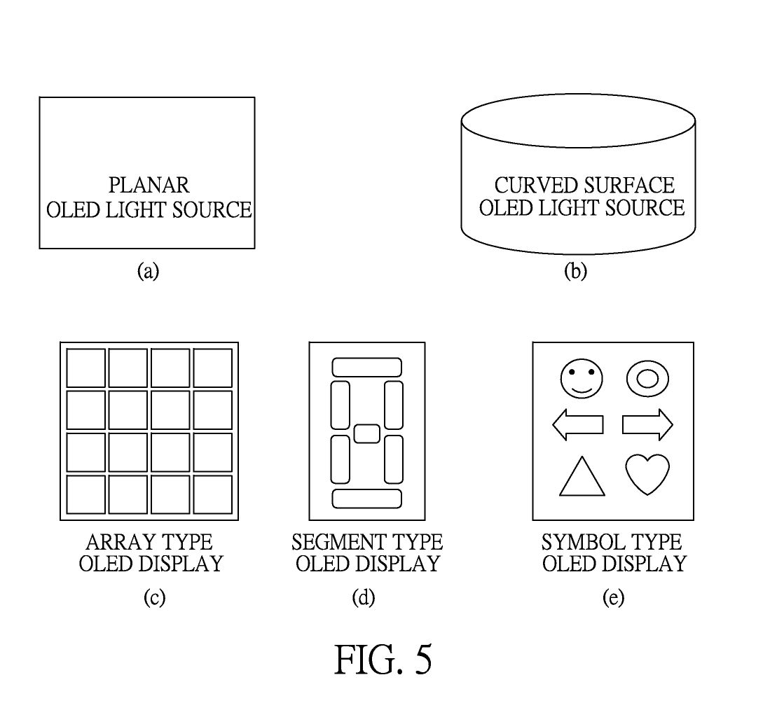

Please refer to FIG. 5, which illustrates plural applications of the OLED touch device of the present invention. As illustrated in FIG. 5, the OLED touch device of the present invention can be applied to lighting: (a) planar OLED light source, and (b) curved surface OLED light source; and applied to display: (c) array type OLED display, (d) segment type OLED display, and (e) symbol type OLED display.

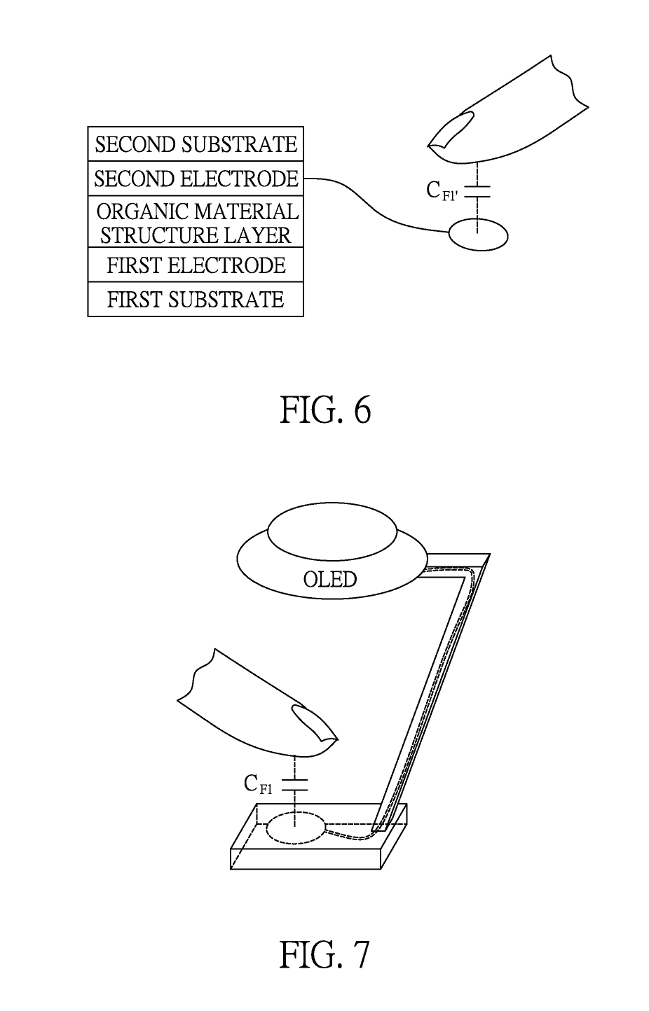

When the OLED touch device of the present invention is used in lighting applications, the touch detection function can be used to provide an on/off switching function and/or a dimming function. That is, a user can control the luminance of an OLED light source by touching the surface of the OLED light source without the need of an additional switch or dimmer. In addition, in a scenario where an OLED light source cannot be reached by a user, the first electrode or second electrode of the OLED light source can be wired to an external electrode to facilitate a touch operation. Please refer to FIG. 6-7, which illustrates an OLED light source of the present invention using an extended wire to provide an on/off switching function and/or a dimming function.

Thanks to the novel designs mentioned above, the present invention possesses the following advantages:

1. The OLED touch device of the present invention can provide a light emitting function and/or a touch detection function by applying a combined voltage source across an OLED structure.

2. The OLED touch device of the present invention can use two substrates to provide two touch planes.

3. The OLED touch device of the present invention can detect a touch event by sensing an amplitude variation, a phase variation, or a frequency variation of an AC voltage of a combined voltage source.

4. The OLED touch device of the present invention can provide four operation modes by enabling/disabling a DC voltage component and/or an AC voltage component of a combined voltage source.

5. The OLED touch device of the present invention can simplify the structure of a touch apparatus to reduce the depth, promote the yield rate, and cut down the cost thereof.

While the invention has been described by way of example and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. An OLED touch device having at least one OLED and a controller, each of said at least one OLED comprising:
a first substrate;
a first electrode located on said first substrate;
an organic material structure layer located on said first electrode;
a second electrode located on said organic material structure layer; and
a second substrate located on said second electrode;
wherein, said control unit is used to apply a combined voltage source across said first electrode and said second electrode of at least one of said at least one OLED to provide a light emitting function and/or a touch detection function, wherein said combined voltage source has a DC voltage component and an AC voltage component, said DC voltage component being used to produce a DC current flowing through said organic material structure layer to provide said light emitting function, and said AC voltage component being used as a touch detection signal, of which a parameter variation is detected by said controller to indicate a touch event, to provide said touch detection function.

2. The OLED touch device as claim 1, wherein said organic material structure layer is selected from a group consisting of an N type organic material layer and a P type organic material layer.

3. The OLED touch device as claim 1, wherein said first substrate is selected from a group consisting of glass, PET, and glass epoxy resin.

4. The OLED touch device as claim 1, wherein said second substrate is selected from a group consisting of glass, and PET.

5. The OLED touch device as claim 1, wherein said first electrode is selected from a group consisting of a transparent electrode and an opaque electrode.

6. The OLED touch device as claim 1, wherein said second electrode is a transparent electrode.

7. The OLED touch device as claim 1, wherein said OLED has a light emission structure selected from a group consisting of a top-emission structure, a bottom-emission structure, and any combination thereof.

8. The OLED touch device as claim 1, wherein said second substrate is used to provide a touch plane.

9. The OLED touch device as claim 8, wherein said first substrate is used to provide another touch plane.

10. The OLED touch device as claim 1, wherein said parameter variation is selected from a group consisting of amplitude variation, phase variation, and frequency variation.

11. The OLED touch device as claim 1, wherein said touch detection function is selected from a group consisting of a self-capacitance touch detection function, a mutual-capacitance touch detection function, and a surface-capacitance touch detection function.

12. The OLED touch device as claim 1, wherein said control unit has a first operation mode for providing said light emitting function and said touch detection function at same time.

13. The OLED touch device as claim 1, wherein said control unit has a second operation mode for providing only said touch detection function.

14. The OLED touch device as claim 1, wherein said control unit has a third operation mode for providing only said light emitting function.

15. The OLED touch device as claim 1, wherein said control unit has a fourth operation mode, in which both said touch detection function and said light emitting function are shut down.

16. The OLED touch device as claim 1, wherein said at least one OLED forms an OLED array, and said control unit has a scan unit for driving said OLED array.

17. The OLED touch device as claim 16, wherein said OLED array is selected from a group consisting of a passive OLED array and an active OLED array.

18. The OLED touch device as claim 1, wherein said at least one OLED is used to form an OLED light source.

19. The OLED touch device as claim 18, wherein said first electrode of said OLED light source is wired to an external electrode for providing a touch operation.

20. The OLED touch device as claim 18, wherein said second electrode of said OLED light source is wired to an external electrode for providing a touch operation.
